(19) United States
(12) Patent Application Publication
(10) Pub. No.: US 2020/0151694 A1
(43) Pub. Date: May 14, 2020

(54) POS OPERATED BY AN APP AND HAVING BOTH CONSUMER SELF-SERVICE ORDERING AND BILLING FUNCTIONS

(71) Applicant: TRUSTED SOLUTIONS CORPORATION, New Taipei city (TW)

(72) Inventor: KUANG HUNG CHENG, NEW TAIPEI CITY (TW)

(21) Appl. No.: 16/189,079

(22) Filed: Nov. 13, 2018

(51) Int. Cl. G06Q 20/20; G06Q 20/18; G06Q 30/06; G06Q 30/04; G06Q 20/10; G06Q 20/30; G06F 17/30; G06F 21/32; G06F 8/61

(52) U.S. Cl. CPC G06Q 20/204; G06Q 20/18; G06Q 30/0641; G06Q 30/04; G06F 8/61; G06Q 20/30; G06F 17/30861; G06F 21/32; G06Q 20/102

(57) ABSTRACT

Disclosed is a point of sale (POS) operated by an application (APP) and having both consumer self-service ordering and billing functions. The APP is operated by a host to serve as a user interface to execute the POS, and the POS provides a cashier ordering and billing interface and a consumer self-service ordering and billing interface, so that the POS have both cashier ordering and billing function and consumer self-service ordering and billing function which can be switched from one to another according to actual requirements and conditions.

### FIELD OF THE INVENTION

The present invention relates to a point of sale (POS), and more particularly to a POS executed by an application (APP).

### BACKGROUND OF THE INVENTION

### 1. Description of the Related Art

To improve operational performance and reduce human errors, present companies with the business activities of commercial marketing and sales such as restaurants, supermarkets, physical/network online stores, logistics companies, etc. generally adopt full electronization and computerization for their distribution management and intend to achieve the effects of lowering cost, and improving management and corporate efficiency. Therefore, it is a main subject for companies to leverage the advantages of high speed and low error rate of the electronization and computerization for their management, and the way of using the POS appropriately is a key factor of success.

As to the operations of a physical store (such as a restaurant), a cashier or a counter is provided for consumers to order a meal or pay the bill, and these operations also include the process of getting or delivering the meal. At present, the point of sale (POS) is used to assist physical shopping, cashiers, and related management operations of a general manned store. Since the cashier at the counter is responsible for the work in the POS including printing an invoice or receipt, collecting payments by credit cards, or scanning barcodes, etc., therefore the POS stores can be operated and the inventory can be kept efficiently to facilitate the management of the stores.

At present, there is another assisted self-service shopping system provided for consumers to place orders and make payments, and such system is an ordering and billing system that saves labor costs.

Since the consumer self-service ordering and billing system (such as a kiosk) is an interactive multimedia self-service machine, the system generally comes with a relatively large touch screen provided for the operation by users and provides information or assists transactions, and it is an application system with independent operations which is not related to the point of sale (POS) whatsoever. The system can be operated by the cashier only and has no consumer self-service ordering and billing functions. If a store has the need for both consumer self-service ordering and billing function and cashier self-service ordering and billing function, then both of the consumer self-service ordering and billing system and the cashier ordering and billing system (POS) and their respective hardware will be required. Such operation is obviously not a perfect one, since it incurs higher costs and more complicated maintenance, management, and information integration.

In view of the drawbacks of the prior art, the inventor of the present invention provides an innovative system to overcome the drawbacks of the prior art.

### 2. Summary of the Invention

Therefore, it is a primary objective of the present invention to provide a POS operated by an APP and having both consumer self-service ordering and billing functions, so that a store may use an APP to execute the POS and the POS also has the functions of the traditional POS system and consumer self-service ordering and billing system to facilitate shop workers and cashiers to carry out the POS operations or to facilitate consumers to carry out the self-service ordering and billing operations, so as to overcome the limitation of the traditional operations requiring several different systems and to meet the requirements of the stores better.

To achieve the aforementioned and other objectives, the present invention discloses a POS operated by an application (APP) and having both consumer self-service ordering and billing functions, characterized in that the POS is installed at a host or a remote server connected to the host, and the application (APP) is run by the host as a user interface to execute the POS, and the POS provides a cashier ordering and billing interface and a consumer self-service ordering and billing interface, so that the POS has both cashier ordering and billing function and consumer self-service ordering and billing function which can be switched from one to another according to actual requirements and conditions.

In an embodiment, the POS provides a cashier ordering and billing interface and a consumer self-service ordering and billing interface, and the host uses the APP as a user interface to execute the POS and provides a login system interface, and the login system interface has at least a login module provided for enter into a cashier ordering and billing interface or a consumer self-service ordering and billing interface.

In this embodiment, the APP is downloaded by a store from a non-specific remote service connected to the host via the Internet, or downloaded from a specific APP platform, and then installed to the host before the APP is executed.

In this embodiment, the login module is at least one selected from the group consisting of a login module operated by pressing or clicking a specific key, a login module sensed by an ID sensor, a login module using an account of a different priority option, and a login module with a mode option, so that the store can determine an operation to be carried out by the cashier ordering and billing interface or by the consumer self-service ordering and billing interface.

In this embodiment, the specific key of the login module is provided for a shop worker to press or click, and different specific keys have the functions of entering into the cashier ordering and billing interface and entering into the consumer self-service ordering and billing interface respectively.

In an embodiment, the login module is sensed by an ID sensor, and the ID sensor is provided for a shop worker to identify an ID recognition, and different IDs represent whether or not there is a priority option for entering into the cashier ordering and billing interface or entering into the consumer self-service ordering and billing interface, and if the ID is verified to have the priority option to enter into the cashier ordering and billing interface or enter into the consumer self-service ordering and billing interface, then an option of entering into the cashier ordering and billing interface and an option of entering into the consumer self-service ordering and billing interface will be shown and provided for an operator to select and enter.

In this embodiment, the ID sensor is one selected from the group consisting of a fingerprint recognition device, a face recognition device, and an iris recognition device.

In this embodiment, the login module using different priority account shows an account input column provided for a shop worker to input a specific account, and different specific accounts represent whether or not there is a priority option to enter into the cashier ordering and billing interface or enter into the consumer self-service ordering and billing interface, and if the ID is verified that to have a priority option to enter into the cashier ordering and billing interface or enter into the consumer self-service ordering and billing interface, then an option of entering into the cashier ordering and billing interface and entering into the consumer self-service ordering and billing interface will be shown and provided for an operator to select and enter.

In an embodiment, the login module with a mode option is an option column provided for selecting to enter into the cashier ordering and billing interface or enter into the consumer self-service ordering and billing interface.

In this embodiment, the cashier ordering and billing interface has a switching module provided for switching and entering into the consumer self-service ordering and billing interface.

In this embodiment, the switching module is an account input column provided for inputting a specific account to enter into the consumer self-service ordering and billing interface.

In this embodiment, the consumer self-service ordering and billing interface comprises an account input column provided for a shop worker to input a specific account, and different specific accounts represent switching to the cashier ordering and billing interface, or directly exiting the APP.

In this embodiment, the cashier ordering and billing interface is a cashier meal ordering and billing interface, and the consumer self-service ordering and billing interface is a consumer meal self-service ordering and billing interface.

In this embodiment, the host is one selected from the group consisting of a mobile phone, a tablet PC, a notebook computer, and a desktop computer.

The above and other objects, features and advantages of this disclosure will become apparent from the following detailed description taken with the accompanying drawings.

### BRIEF DESCRIPTION OF THE DRAWINGS

FIG. 1 is a block diagram of the present invention.

FIG. 2 is a schematic view of selecting and switching between a cashier ordering and billing interface and consumer self-service ordering and billing interface in accordance with the present invention.

### DESCRIPTION OF THE PREFERRED EMBODIMENTS

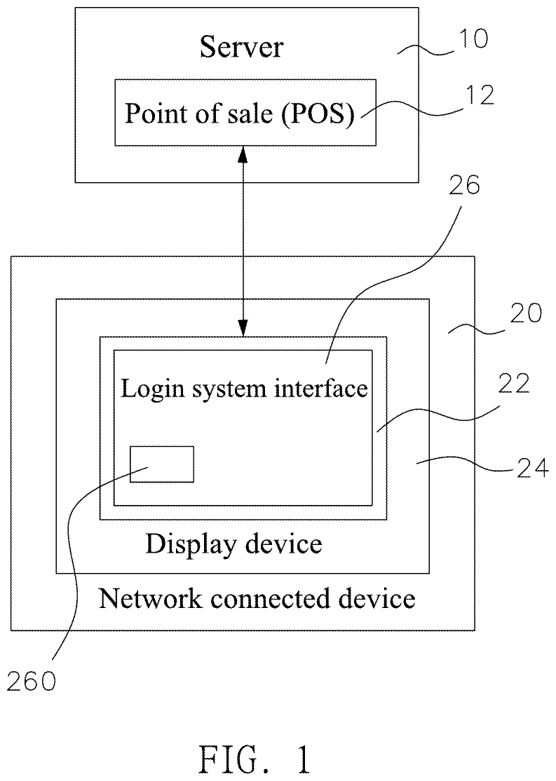

With reference to FIG.1 for a block diagram illustrating a point of sale (POS) operated by an application (APP) and having both consumer self-service ordering and billing functions in accordance with the present invention, the POS 12 is installed at a host 20 or a remote server 10 connected to the host 20, and the APP 22 is run by the host 20 and serves as a user interface to execute the POS 12.

The host 20 comprises at least a display device 24, and when the APP 22 is executed, the APP 22 is shown on the display device 24.

The POS 12 is installed at the host 20, or may be installed at the remote service as shown in FIG. 1. In other words, the installation position of the POS 12 of the present invention is limited specifically. Regardless of the installation positon of the POS 12, the POS 12 is installed at a position where the main functional operations are executed and where the main data files are stored. Some of the functions of the POS 12 may be executed at the host 20 and some of the data files are stored in the host 20, or some of the functions are executed at the remote server 10 and some of the data files are stored in the remote server 10.

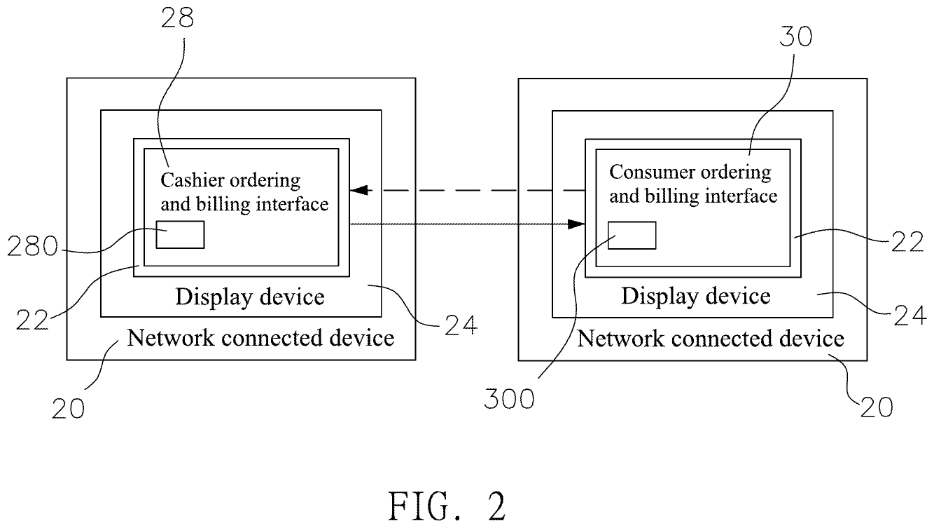

With reference to FIG. 2, the POS 12 provides a cashier ordering and billing interface 28 and a consumer self-service ordering and billing interface 30, so that the POS 12 has the functions of both cashier ordering and billing interface 28 and consumer self-service ordering and billing interface 30 at the same time. For example, the host 20 has a display device 24 configured to be facing consumers and provided for displaying a consumer self-service ordering and billing interface 30, so that the consumers may carry out the self-service functions of ordering an item, a meal, or a beverage and then paying the bill and the host 20 further has another display device 24 configured to be facing a cashier and provided for displaying a cashier ordering and billing interface 28, so that the cashier may order an item, a meal, or a beverage and then collect the consumer's payment.

After the host 20 uses the APP 22 as a user interface to execute the POS 12, a login system interface 26 may be provided selectively, wherein the login system interface 26 has at least a login module 260 provided for entering into a cashier ordering and billing interface 28 or a consumer self-service ordering and billing interface 30.

The consumer self-service ordering, and billing interface 30 may be used for a. self-service function such as ordering a meal, shopping, making a reservation, or paying a bill. The cashier ordering and billing interface 28 may be used for placing orders, collecting payments, and checking out, etc. Of course, the cashier ordering and billing interface 28 may also include various different functional operations such as arranging a shift change, preparing stock, making an inquiry, or related internal information, receiving cash, logging out from the system, etc.

Wherein, the host 20 includes, but not limited to, one selected from the group consisting of a mobile phone, a tablet PC, a notebook computer, and a desktop computer.

Wherein, the display device 24 includes, but not limited to, a touch screen provided to facilitate users to carry out the operation intuitively.

Wherein, the APP 22 is downloaded by a store from a non-specific remote server connected to the host 20 via the Internet, or downloaded from a specific APP platform and then installed to the host 20 before the APP is executed.

Wherein, the login module 260 is at least one selected from the group consisting of a login module operated by pressing or clicking a specific key, a login module sensed by an ID sensor, a login module using an account of a different priority option, and a login module with a mode option, so that the store can determine an operation to be carried out by the cashier ordering and billing interface or by the consumer self-service ordering and billing interface.

Wherein, the specific key of the login module is provided for a shop worker to press or click, and different specific keys have the functions of entering into the cashier ordering and billing interface 28 and entering into the consumer self-service ordering and billing interface 30 respectively.

Wherein, the login module is sensed by an ID sensor, and the ID sensor is provided for a shop worker to identify an ID, and different IDs represent whether or not there is a priority option for entering into the cashier ordering and billing interface 28 or entering into the consumer self-service ordering and billing interface 30, and if the ID is verified to have the priority option to enter into the cashier ordering and billing interface 28 or enter into the consumer self-service ordering and billing interface 30, then an option of entering into the cashier ordering and billing interface 28 and an option of entering into the consumer self-service ordering and billing interface 30 will be shown and provided for an operator to select and enter. For example, if the specific account or ID is verified to have a priority option to enter into the cashier ordering and billing interface or enter into the consumer self-service ordering and billing interface after the specific account is entered, or the ID is recognized, then the option of entering into the cashier ordering and billing interface 28 and the option of entering into the consumer self-service ordering and billing interface 30 will be shown and provided for an operator to select and enter, so that the host 29 can enter into the cashier ordering and billing interface 28 or the consumer self-service ordering and billing interface 30 according to work requirements.

Wherein, the login module 260 is an option column provided for selecting and entering into the cashier ordering and billing interface 28 or the consumer self-service ordering and billing interface 30, so that the host 29 can enter into the cashier ordering and billing interface 28 or the consumer self-service ordering and billing interface 30 according to work requirements.

In FIG. 2, the present invention provides a POS operated by an APP and having both consumer self-service ordering and billing functions capable of switching its application programming interface. The cashier ordering and billing interface 28 has a switching module 280 provided for switching and entering into the consumer self-service ordering and billing interface 30. In other words, when the shop worker operates the cashier ordering and billing interface 28, the shop worker may switch into to the consumer self-service ordering and billing interface 30 by using the switching module 280 of the cashier ordering and billing interface 28 as needed. For example, when a store cashier takes off, the consumer self-service ordering and billing interface 30 is switched and then the display device 24 turned into a direction facing consumers, so that the consumers may carry out the ordering and billing functions through the consumer self-service ordering and billing interface 30.

Wherein, the switching module 280 is an account input column provided for inputting a specific account to enter into the consumer self-service ordering and billing interface 30.

The consumer self-service ordering and billing interface 30 comprises an account input column 300 provided for a shop worker to input a specific account, and different specific accounts represent switching to the cashier ordering and billing interface 28, or directly exiting the APP 22. As to consumers, they do not know any specific account, so that the consumers can be restricted from switching to the cashier ordering and billing interface 28, or directly exiting the APP 22 in order to prevent ruining the continual use or operation of the self-service ordering and billing functions by the next consumer.

The consumer self-service ordering and billing interface 30 may further provide store information, marketing information, or small game software, etc. The POS not just saves labor costs only, but also provides the marketing and advertising functions.

The POS operated by an APP and having both consumer self-service ordering and billing functions in accordance with the present invention is applicable for restaurants. In a restaurant, the cashier ordering and billing interface 28 may be a cashier meal ordering and billing interface, and the consumer self-service ordering and billing interface 30 may be a consumer self-service meal ordering and billing interface. Of course, the invention is also applicable in other industries.

In an application of the POS operated by an APP and having both consumer self-service ordering and billing functions in accordance with the present invention, the login module 260 of the login system interface 26 is provided to enter into the cashier ordering and billing interface 28 or the consumer self-service ordering and billing interface 30. When the logon module 260 enters into the cashier ordering and billing interface, it is used as the point of sale (POS). For example, the POS may be used for the function of placing orders, collecting payments, and checking out, and the POS may include the functions of arranging shift changes, preparing stocks, making an inquiry, compiling related internal information of the store, receiving cash, and logging out from the system. When there is no staff in the store (for example, when the cashier leaves the counter or takes off) the switching module 280 may be used to enter into the consumer self-service ordering and billing interface 30 which is provided for consumers to carry out the ordering and billing functions on their own. When the login system interface 26 enters into the consumer self-service ordering and billing interface 30 through the login module 260, the consumers are allowed to carry out the ordering and billing function on their own in an unmanned store.

Therefore, the stores using the POS operated by an APP and having both consumer self-service ordering and billing functions in accordance with the present invention may have both consumer self-service ordering and billing and cashier ordering and billing modes in a single system at the same time. Further, the system service method can be adjusted anytime according to different using hardware or different schedules of shop workers. In addition, the login system interface 26 is a basic POS, and the POS 12 may switch its ordering and billing method and process according to the store's requirements, and different interfaces (such as the cashier ordering and billing interface 28 and the consumer self-service ordering and billing interface 30) provide different user interfaces, so that both accounting and inventory can be managed by the system synchronously.

By the POS operated by an APP and having both consumer self-service ordering and billing functions in accordance with the present invention, the same POS 12 can enter into either one of the operation interfaces (the cashier ordering and billing interface 28 or the consumer self-service ordering and billing interface 30) through the login module 260 of the login system interface 26, so that a single system provides both functions of the traditional POS and the consumer self-service ordering and billing system to facilitate store workers and cashiers to carry out the work operations or to facilitate consumers to carry out their self-service ordering and billing operations. This invention improves over the traditional standalone system with the limitation on the operation of the POS and the consumer self-service ordering and billing system, and thus the invention can meet the requirements of the stores better.

In summation of the description above, the present invention improves over the prior art and complies with patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A point of sale (POS) operated by an application (APP) and having both consumer self-service ordering and billing functions, characterized in that the POS is installed at a host or a remote server connected to the host, and the application (APP) is run by the host as a user interface to execute the POS, and the POS provides a cashier ordering and billing interface and a consumer self-service ordering and billing interface, so that the POS has both cashier ordering and billing function and consumer self-service ordering and billing function which can be switched from one to another according to actual requirements and conditions.

2. The POS operated by an APP and having both consumer self-service ordering and billing functions according to claim 1, wherein the POS provides a cashier ordering and billing interface and a consumer self-service ordering and billing interface, and the host uses the APP as a user interface to execute the POS and provides a login system interface, and the login system interface has at least a login module provided for entering into a cashier ordering and billing interface or a consumer self-service ordering and billing interface.

3. The POS operated by an APP and having both consumer self-service ordering and billing functions according to claim 1, wherein the APP is downloaded by a store from a non-specific remote service connected to the host via the Internet, or downloaded from a specific APP platform, and then installed to the host before the APP is executed.

4. The POS operated by an APP and having both consumer self-service ordering and billing functions according to claim 2, wherein the login module is at least one selected from the group consisting of a login module operated by pressing or clicking a specific key, a login module sensed by an ID sensor, a login module using an account of a different priority option, and a login module with a mode option, so that the store can determine an operation to be carried out by the cashier ordering and billing interface or by the consumer self-service ordering and billing interface.

5. The POS operated by an APP and having both consumer self-service ordering and billing functions according to claim 4, wherein login module operated by pressing or clicking a specific key, the specific key provided for a shop worker to press or click, and different specific keys have the functions of entering into the cashier ordering and billing interface and entering into the consumer self-service ordering and billing interface respectively.

6. The POS operated by an APP and having both consumer self-service ordering and billing functions according to claim 4, wherein the login module sensed by an ID sensor, the ID sensor is provided for a shop worker to identify an ID, and different IDs represent whether or not there is a priority option for entering into the cashier ordering and billing interface or entering into the consumer self-service ordering and billing interface, and if the ID is verified to have the priority option to enter into the cashier ordering and billing interface or enter into the consumer self-service ordering and billing interface, then an option of entering into the cashier ordering and billing interface and an option of entering into the consumer self-service ordering and billing interface will be shown and provided for an operator to select and enter.

7. The POS operated by an APP and having both consumer self-service ordering and billing functions according to claim 6, wherein the ID sensor is one selected from the group consisting of a fingerprint recognition device, a face recognition device, and an iris recognition device.

8. The POS operated by an APP and having both consumer self-service ordering and billing functions according to claim 4, wherein the login module using an account of a different priority option shows an account input column provided for a shop worker to input a specific account, and different specific accounts represent whether or not there is a priority option to enter into the cashier ordering and billing interface or enter into the consumer self-service ordering and billing interface, and if the ID is verified that to have a priority option to enter into the cashier ordering and billing interface or enter into the consumer self-service ordering and billing interface, then an option of entering into the cashier ordering and billing interface and entering into the consumer self-service ordering and billing interface will be shown and provided for an operator to select and enter.

9. The POS operated by an APP and having both consumer self-service ordering and billing functions according to claim 4, wherein the login module with a mode option is an option column provided for selecting to enter into the cashier ordering and billing interface or enter into the consumer self-service ordering and billing interface.

10. The POS operated by an APP and having both consumer self-service ordering and billing functions according to claim 1, wherein the cashier ordering and billing interface has a switching module provided for switching and entering into the consumer self-service ordering and billing interface.

11. The POS operated by an APP and having both consumer self-service ordering and billing functions according to claim 10, wherein the switching module is an account input column provided for inputting a specific account to enter into the consumer self-service ordering and billing interface.

12. The POS operated by an APP and having both consumer self-service ordering and billing functions according to claim 1, wherein the consumer self-service ordering and billing interface comprises an account input column provided for a shop worker to input a specific account, and different specific accounts represent switching to the cashier ordering and billing interface, or directly exiting the APP.

13. The POS operated by an APP and having both consumer self-service ordering and billing functions according to claim 1, wherein the cashier ordering and billing interface is a cashier meal ordering and billing interface, the consumer self-service ordering and billing interface is a consumer self-service meal ordering and billing interface.

14. The POS operated by an APP and having both consumer self-service ordering and billing functions according to claim 1, wherein the host is one selected from the group consisting of a mobile phone, a tablet PC, a notebook computer, and a desktop computer.
